(19) United States
(12) Patent Application Publication
(10) Pub. No.: US 2016/0231710 A1
(43) Pub. Date: Aug. 11, 2016

(54) Cause and Effect Sound Emitting Alarm Clock

(71) Applicant: Kirt O. Marsh, Petersburg, AK (US)

(72) Inventor: Kirt O. Marsh, Petersburg, AK (US)

(21) Appl. No.: 14/709,581

(22) Filed: May 12, 2015

Related U.S. Application Data
(60) Provisional application No. 61/992,785, filed on May 13, 2014.

(51) Int. Cl. G04G 13/02; G08B 3/10

(52) U.S. Cl. CPC G04G 13/023; G08B 3/10

(57) ABSTRACT

The present invention is an alarm clock which emits cause and effect related sounds. The alarm clock provides for a user selectable “alarm sound” such as a “duck quacking” alarm sound, and a corresponding “terminating sound” such as a “boom and splash” terminating sound so as to simulate the sound of a shotgun blast and a duck falling into water in response to terminating a “duck quacking” alarm sound. In practice, using the alarm clock a user selects an alarm sound and an alarm time and then goes to sleep or performs another function. Upon arrival of the predetermined time, the alarm sound emits from the alarm clock waking or altering the user. The user then turns the alarm off causing a terminating sound, which corresponds to the alarm sound, and more especially to a sound associated with the termination of the alarm sound, to emit from the alarm clock.

### CROSS REFERENCE TO RELATED APPLICATIONS

This US nonprovisional utility patent application claims the benefit under 35 USC §119(e) of U.S. provisional application No. 61/992,785 filed May 13, 2014 which is incorporated in its entirety by this reference.

### FIELD OF THE INVENTION

The present invention relates to alarm clocks and more especially to alarm clocks that emit cause and effect related sounds.

### BACKGROUND OF THE INVENTION

Alarm clocks are widely used and are available in a variety of types and models. Such clocks typically have a singular default sound option which functions as the alarm sound which will emit from the alarm clock at a predetermined user selectable time. Further such alarm clocks typically have a “snooze” button or option and an “off” button or option, which when selected or activated causes the clock to cease emitting the alarm sound.

### SUMMARY OF THE INVENTION

The present invention is an alarm clock which emits cause and effect related sounds. In a preferred embodiment, the alarm clock provides for a user selectable “alarm sound” for instance a “duck quacking” alarm sound, and a corresponding “terminating sound” such as a “boom and splash” terminating sound, so as to simulate the sound of a shotgun blast and a duck falling into water in response to terminating a “duck quacking” alarm sound. In practice, using the alarm clock a user selects an alarm sound and an alarm time and then goes to sleep. Upon arrival of the predetermined time, the alarm sound emits from the alarm clock waking the user. The user then turns the alarm off causing a terminating sound, which corresponds to the alarm sound, and more especially to a sound associated with the termination of the alarm sound, to emit from the alarm clock.

### DESCRIPTION OF DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a trimetric view of the invention.

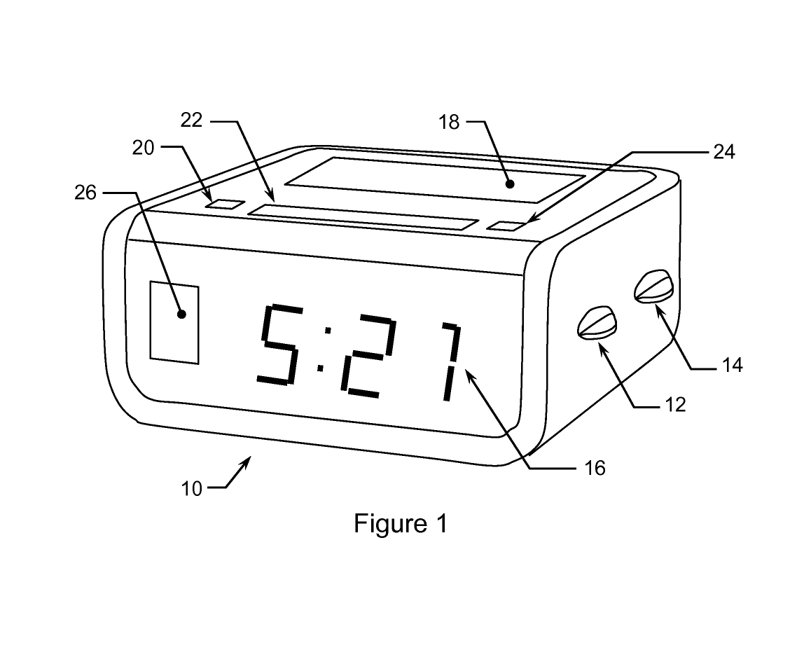

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are included to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

In order to facilitate the understanding of the present invention in reviewing the drawing accompanying the specification, a feature table is provided below. It is noted that like features are like numbered throughout all of the figures.

FEATURE TABLE

| # | Feature | # | Feature |
|---|---|---|---|
| 10 | Cause and effect sound emitting | 12 | On/Off volume control dial |
| | alarm clock | | |
| 14 | Alarm type selector dial | 16 | Time display |
| 18 | Speaker | 20 | Alarm time selection button |
| 22 | Snooze bar | 24 | Alarm activation button |
| 26 | Alarm status display | | |

Referring now to the drawing, a first embodiment of the invention is a cause and effect sound emitting alarm clock 10 (CESEAC) which is similar to a conventional alarm clock (see Appx A) except that CESEAC 10 is adapted to emit an “alarm sound” and a corresponding “terminating sound”. CESEAC 10 preferably includes an On/Off and volume control dial 12, an alarm type selector dial 14, a time display 16, a speaker 18, an alarm time selection button 20, a snooze bar 22, an alarm activation button 24, and an alarm status display 26.

CESEAC 10 preferably includes multiple alarm sounds from which a user may select, each of such alarm sounds having a corresponding terminating sound. Once an alarm is selected, an image or icon corresponding to the alarm (e.g. an image of a flying duck for a “Ducks” alarm), along with the alarm status (e.g. armed or not armed), is preferably displayed by alarm status display 26. Further, CESEAC 10 may also have user definable alarm sounds and terminating sounds that the user may for instance electronically input into CESEAC 10. Each terminating sound is adapted to correspond to the respective alarm sound, and more especially to correspond to a termination of the respective alarm sound. Non-limiting examples of alarm sounds and corresponding terminating sound are for instance providing in the following “Alarm Table”.

ALARM TABLE

| Alarm Name | Alarm sound | Terminating sound | Implied action if any |
|---|---|---|---|
| Ducks | Ducks quacking | Boom and splash | The quacking ducks are shot |
| | | | and fall into water |
| Clock | Alarm clock ringing | Hammer smashing an | The alarm clock is struck |
| | | alarm clock | with a hammer |
| Fire | Fire alarm sounding | Water spraying from a | The fire is extinguished by |
| | | fire hose | spraying water from a fire |
| | | | hose onto the fire |
| Beethoven | Beethoven's 5^{th} | Applause | An audience applauds the |
| | symphony | | symphony |
| 1812 | Tchaikovsky's 1812 | Fireworks and cannon | Fireworks are lit and a |
| | overture | fire | cannons are fired |
| Engine | Engine turning over | Engine start and rev | The engine is started and is |
| | attempting to start | | revving |
| Fishing | Fishing reel rotating | Splash of water and | The fish is caught and landed |
| | and fishing line paying | fish flopping on boat | in a boat |
| | out and reeling back in | deck | |
| Fly | Fly buzzing | Swatting | The fly is smashed by |
| | | | swatting the fly with a fly |
| | | | swatter. |
| Crash | Skidding of tires | Crash sound | A skidding vehicle crashes |
| | | | into an object |
| User1 | A first user defined | A first user defined | A user defined termination |
| | alarm sound | terminating sound | action that corresponds to the |
| | | | termination of the user |
| | | | defined alarm sound |

In practice, to use CESEAC 10a user selects an alarm name and time, arms the alarm, and then goes to sleep or performs another function wherein the user desires an alarm to go off at a predetermined time. Upon arrival of the predetermined time, the alarm sound emits from the alarm clock waking or alerting the user. The user then turns the alarm off causing a terminating sound, which corresponds to the alarm sound and more especially to a sound associated with the termination of the alarm sound, to emit from CESEAC 10 for preferably a brief period of time. CESEAC 10 further preferably includes a “snooze” function in which case when the snooze function is actuated, the terminating sound emits briefly but at repeating intervals until the user turns off the alarm (cancels the alarm). In the case of a user defined alarm, CESEAC 10 is adapted such that a user is able to upload to CESEAC 10, one or more user defined alarms having corresponding alarm sounds and terminating sounds.

In an alternate second embodiment, the invention is provided as provided as a software program and more especially as a mobile application or “app” (see Appx B). The second embodiment of the invention, when loaded onto a smartphone (see Appx C), a smartwatch (see Appx D), a tablet computer (see Appx E) or like (preferably mobile) computing device, causes the computing device to function substantially according to the described first embodiment of the invention.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus adapted to emit a natural sound simulating alarm sound and a corresponding natural sound simulating terminating sound, wherein said terminating sound corresponds to the termination of said alarm sound and simulates a natural sound that would naturally emanate upon termination of an actual natural sound which said alarm sound simulates, and wherein when said apparatus is emitting said alarm sound and a user terminates said alarm sound, said apparatus automatically emits said terminating sound corresponding to the termination of said alarm sound.

2. The apparatus of claim 1, wherein said apparatus is adapted to perform a snooze function, and wherein when said snooze function is actuated, said terminating sound emits from said apparatus at repeating intervals until alarm is cancelled.

3. The apparatus of claim 1, wherein said apparatus includes a plurality of user selectable alarm sounds, each alarm sound having a corresponding terminating sound.

4. The apparatus of claim 1, wherein said apparatus includes a user definable alarm sound and a user definable terminating sound.

5. The apparatus of claim 1, wherein said apparatus includes at least one of an alarm sound of “ducks quacking” and a corresponding terminating sound of at least one of “boom” and “splash”, an alarm sound of “ringing alarm clock” and a corresponding terminating sound of “hammer smashing alarm clock”, an alarm sound of “fire alarm” and a corresponding terminating sound of “water spraying fire hose”, an alarm sound of “Beethoven's 5^{th} symphony” and a corresponding terminating sound of “applause”, an alarm sound of “Tchaikovsky's 1812 overture” and a corresponding terminating sound of “Fireworks and cannon fire”, an alarm sound of “trying to start engine” and a corresponding terminating sound of “engine revving”, an alarm sound of at least one of “fishing reel rotating” and “fishing line paying out” and a corresponding terminating sound of at least one of “splashing” and “fish flopping”, and an alarm sound of “fly buzzing” and a corresponding terminating sound of “swatting”.

6. The apparatus of claim 1, wherein said apparatus defines at least one of a standalone alarm clock and a computing device programmed to function as an alarm clock.

7. The apparatus of claim 6, wherein said computing device further defines a mobile computing device.

8. The apparatus of claim 6, wherein said standalone alarm clock further defines a clock radio alarm clock, and wherein said computing device further defines at least one of a smartphone, a smartwatch, and a tablet computer.

9. An alarm clock adapted to emit a natural sound simulating alarm sound and a corresponding natural sound simulating terminating sound, wherein said terminating sound corresponds to the termination of said alarm sound and simulates a natural sound that would naturally emanate upon termination of an actual natural sound which said alarm sound simulates, and wherein when said alarm clock is emitting said alarm sound and a user terminates said alarm sound, said apparatus automatically emits said terminating sound.

10. The alarm clock of claim 9, wherein said alarm clock is adapted to perform a snooze function, and wherein when said snooze function is actuated, said terminating sound emits from said alarm clock at repeating intervals until alarm is cancelled.

11. The alarm clock of claim 9, wherein said alarm clock includes a plurality of user selectable alarm sounds, each alarm sound having a corresponding terminating sound.

12. The alarm clock of claim 9, wherein said alarm clock includes a user definable alarm sound and a user definable terminating sound.

13. The alarm clock of claim 9, wherein said alarm clock at least one of an alarm sound of “ducks quacking” and a corresponding terminating sound of at least one of “boom” and “splash”, an alarm sound of “ringing alarm clock” and a corresponding terminating sound of “hammer smashing alarm clock”, an alarm sound of “fire alarm” and a corresponding terminating sound of “water spraying fire hose”, an alarm sound of “Beethoven's 5^{th} symphony” and a corresponding terminating sound of “applause”, an alarm sound of “Tchaikovsky's 1812 overture” and a corresponding terminating sound of “Fireworks and cannon fire”, an alarm sound of “trying to start engine” and a corresponding terminating sound of “engine revving”, an alarm sound of at least one of “fishing reel rotating” and “fishing line paying out” and a corresponding terminating sound of at least one of “splashing” and “fish flopping”, and an alarm sound of “fly buzzing” and a corresponding terminating sound of “swatting”.

14. The alarm clock of claim 9, wherein said alarm clock defines a programmed computing device.

15. The alarm clock of claim 14, wherein said computing device further defines a mobile computing device.

16. The alarm clock of claim 14, wherein said computing device further defines at least one of a smartphone, a smartwatch, and a tablet computer.

17. An apparatus adapted to emit a natural sound simulating alarm sound and a corresponding natural sound simulating terminating sound, wherein said terminating sound corresponds to the termination of said alarm sound and simulates a natural sound that would naturally emanate upon termination of an actual natural sound which said alarm sound simulates, and wherein said apparatus includes at least one of an alarm sound of “ducks quacking” and a corresponding terminating sound of at least one of “boom” and “splash”, an alarm sound of “ringing alarm clock” and a corresponding terminating sound of “hammer smashing alarm clock”, an alarm sound of “fire alarm” and a corresponding terminating sound of “water spraying fire hose”, an alarm sound of “Beethoven's 5^{th} symphony” and a corresponding terminating sound of “applause”, an alarm sound of “Tchaikovsky's 1812 overture” and a corresponding terminating sound of “Fireworks and cannon fire”, an alarm sound of “trying to start engine” and a corresponding terminating sound of “engine revving”, an alarm sound of at least one of “fishing reel rotating” and “fishing line paying out” and a corresponding terminating sound of at least one of “splashing” and “fish flopping”, and an alarm sound of “fly buzzing” and a corresponding terminating sound of “swatting”.

18. The apparatus of claim 17, wherein said apparatus defines at least one of a standalone alarm clock and a computing device programmed to function as an alarm clock.

19. The apparatus of claim 18, wherein said computing device further defines a mobile computing device.

20. The apparatus of claim 18, wherein said standalone alarm clock further defines a clock radio alarm clock, and wherein said computing device further defines at least one of a smartphone, a smartwatch, and a tablet computer.

21. An apparatus adapted to emit a natural sound simulating alarm sound and a corresponding natural sound simulating terminating sound, wherein said terminating sound corresponds to the termination of said alarm sound and simulates a natural sound that would naturally emanate upon termination of an actual natural sound which said alarm sound simulates.
